(19) United States
(12) Patent Application Publication
(10) Pub. No.: US 2004/0133467 A1
(43) Pub. Date: Jul. 8, 2004

(54) Method and apparatus for selecting streaming media in real-time

(76) Inventor: Gregory Aaron Siler, Garland, TX (US)

Correspondence Address: ROBERTS ABOKHAIR & MARDULA, SUITE 1000, 11800 SUNRISE VALLEY DRIVE, RESTON, VA, 20191, US

(21) Appl. No.: 10/463,120

(22) Filed: Jun. 17, 2003

Related U.S. Application Data
(63) Continuation of application No. 09/642,037, filed on Aug. 18, 2000, now abandoned.
Application No. 09/642,037 is a continuation-in-part of application No. 09/625,443, filed on Jul. 26, 2000, now abandoned.

(51) Int. Cl. G06F 17/60

(52) U.S. Cl. 705/14; 709/218

(57) ABSTRACT

Streaming media over a packet switched network includes processes for tracking which users are receiving a particular media stream and how long each of the users receives in order to collect time line information. Advertisements are preferably selected in real-time based on predefined criteria and switched, in response to a trigger, in place of a source signal during a streaming session.

### RELATED APPLICATIONS

The present application is a continuation-in-part of commonly assigned and copending U.S. patent application Ser. No. 09/625,443, entitled “Method and Apparatus for Streaming Media”, filed on Jul. 26, 2000, the disclosure of which is hereby incorporated herein by reference.

### FIELD OF THE INVENTION

The invention pertains to streaming media over packet switched data networks, and more particularly to selecting in real-time advertising to be inserted into media streams based on predefined criteria.

### BACKGROUND OF THE INVENTION

Streaming is a process for transmitting audio, video, audio/video and other types of continuous signals, which have been digitized, over packetized data networks such as the Internet for nearly contemporaneous playback. A signal is streamed by encoding the signal as a series of data packets and sending the data packets over a packet switched data network in a manner that supports contemporaneous or nearly contemporaneous playback on a host computer using a player application. Because there are no quality of service or deliver guarantees provided by currently adopted Internet protocols, streaming applications must provide mechanisms for dealing with lost and delayed packets, flow control and encoding and compression, among other problems. Presently, there are several streaming standards and approaches, including those used by the RealPlayer® of RealNetworks, Inc, the Windows Media Player™ of Microsoft Corporation, and the QuickTime® player of Apple Computer, Inc., for encoding and controlling the stream. Prerecorded content, such as sound recordings and video tapes, and “live” content, such as retransmission of radio and television broadcasts, are presently being transmitted over the Internet using streaming. Graphical advertisements are also transmitted for displaying on a computer screen in connection with the playing of the media stream on the computer. In addition, audio, video or other streaming media advertisements are sometimes transmitted prior to transmission of the content.

### SUMMARY OF THE INVENTION

The invention has as a general objective improved methods and apparatus for a system of streaming audio and/or video signals, and in particular improvements concerning the use of advertising in connection with such streaming.

According to one feature of an embodiment of a system for streaming audio and/or video signals described below, audio advertisements are inserted into a third party content signal, such as a terrestrial radio broadcast, at a point at which the signal is being turned into a data stream for transmission across, at least in part, a packet switched network, such as the Internet, to a user's computer for contemporaneous playback. The insertion takes place during the streaming, not just at the beginning of the streaming as prior art methods have done. Thus, advertising may be inserted, for example, in place of advertising contained in the original signal. Advertising in a terrestrial radio broadcast, which is targeted to a local audience, can be replaced in real time, during streaming, with advertising targeted for a different audience, such as a national audience or an audience with a different demographic profile. To enable insertion or overlaying of advertisements, a trigger signal received from a content provider causes the streaming to switch between a third party content signal and a local signal containing an audio or audio/video insert. In the preferred embodiment, a first trigger signal is received indicating that a second trigger signal will soon be received. In the preferred embodiment, it is the receipt of the second trigger signal that causes the streaming to switch between the third party content signal and the local signal containing an audio or audio/video insert. Furthermore, according to another inventive feature, graphical advertising files can also be transmitted for display on the user's computer, for example in a web browser application and/or streaming media player, in conjunction with the streaming advertisement.

According to another feature of the embodiment of the system for the streaming audio and/or video signals described below, users of media streams are tracked as the stream is being played, thereby enabling real-time collection of “time-line” information on a stream's audience, including exposure to any advertisements placed in the stream and any non-streaming advertisements displayed on a computer in connection with the media stream. This information may include how many people are listening or viewing a stream at any given time, and how long they have been listening. The invention thus is able to provide information on users that is more accurate than sampling methods like those employed in traditional media. It is also more accurate than tracking only the commencement of a stream or a user “clicking through” a graphical advertisement displayed simultaneously with the stream. Pricing for the advertising inserted into a media stream can thus be determined based on the actual number of users who hear and/or see the advertisements. Real time reporting on users may also be made available to content providers and advertisers. By further obtaining demographic information from a user, the invention may be further used to generate real-time information on the demographic composition of an audience. Such real time demographic information may be used to select in real-time advertising for insertion into the stream or display of graphical advertising at the host computer, or both. Such information may also be used to determine pricing for the advertising. Furthermore, selection of advertising in real-time may additionally or alternatively be based on other predefined criteria such as product code separation, frequency of play of a particular advertisement, the interests of the audience and/or the like.

### BRIEF DESCRIPTION OF THE DRAWINGS

Following is a detailed description of a method and apparatus for streaming audio and/or video signals, made in reference to the accompanying drawings, of which:

FIG. 1 is a block schematic diagram of a client server system for streaming audio and video, tracking users and pushing rich media advertising;

FIG. 2 is a flow diagram representing a set up process for a streaming service provided with the system of FIG. 1;

FIG. 3 is a flow chart representing a process of a user client for updating advertising displayed in connection with playing of the stream;

FIG. 4 is a preferred embodiment flow chart representing a process by which a server updates advertising displayed in connection with the playing of the stream;

FIG. 5 is a flow chart for selecting and playing advertisements in real-time based on predefined criteria; and

FIG. 6 is a block schematic diagram of a client server system for streaming audio and video, tracking users, selecting advertisements in real time and pushing rich media advertising.

### DETAILED DESCRIPTION

In the following description, like numbers refer to like parts.

When used herein, the term “computer” refers to any device capable of communicating over a data network and decoding for nearly simultaneous playback of an incoming data stream that is encoded with audio and/or video signals. Such a stream is referred to herein as a media stream. The audio and/or video signals, once decoded, may be played back on the computer or another device for reproducing the sound and/or video represented by the signals. A computer may further include or be associated with a visual display. In the preferred embodiments described herein, a computer takes the form of a microprocessor-based personal computer, that includes a general purpose microprocessor, temporary program and data storage, such as random access memory, permanent program and data storage, such as a disk drive, a monitor or other visual display for displaying graphics, a sound card for decoding and converting digital signals to analog signals, and a keyboard and/or mouse for receiving data from a user. However, computers may also include limited function “Internet appliances having limited display, data, data input, and user programming capabilities, such as personal organizers, telephones and other limited or special purpose devices.

The term “packet network” refers generally to one or more interconnected public and/or private networks that route packets or frames of data, as opposed to circuit switched networks and television or radio broadcast networks. Packet Network includes the system of interconnected computer networks known as the “Internet” that route data packets using the Internet Protocol (IP) as it exists presently or in the future.

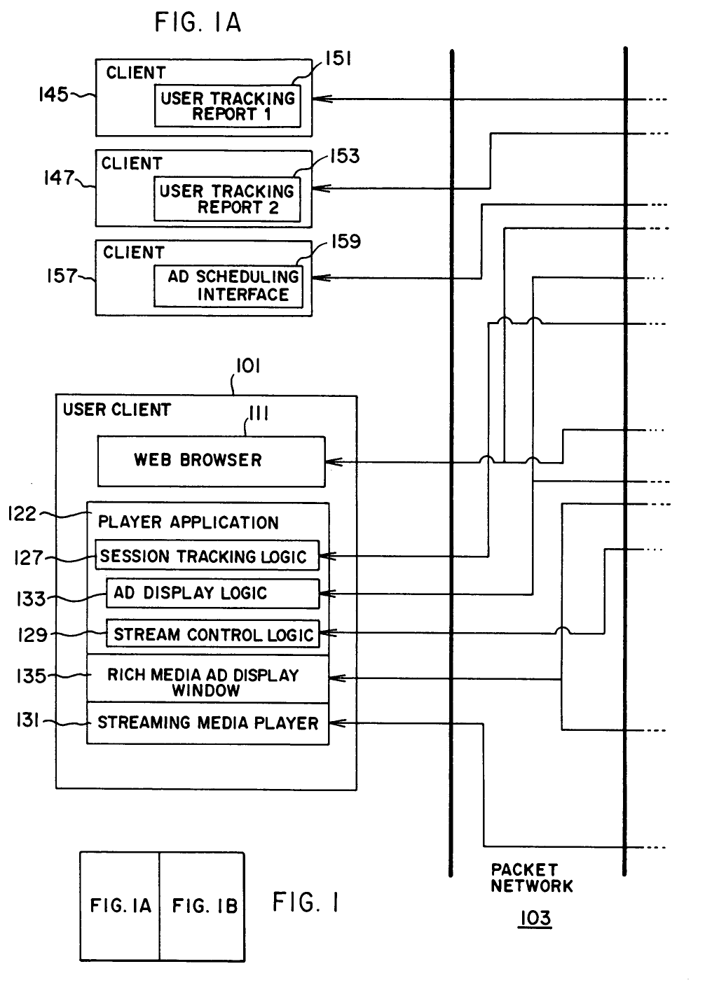

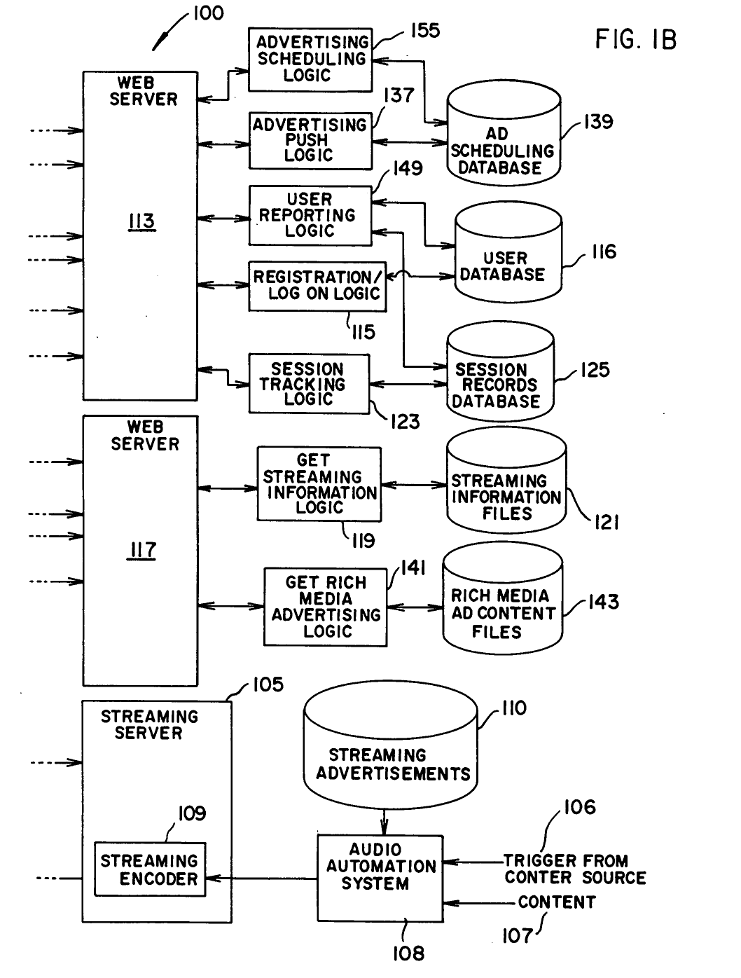

Referring now to FIG. 1, streaming system 100 provides a streaming service in which it transmits, or causes transmission of, audio, and/or audio/video signals as a data stream. A client computer 101 functions as a device for a user to enjoy the streaming service. Client computer 101 is connected directly or indirectly, such as through a dial up connection, a wireless gateway, a cable modem, a xDSL modem, or local area network, to packet network 103. The data stream is transmitted by a streaming server 105 through packet network 103 to the client computer. Although only one client computer 101 is illustrated for purposes of explanation, the same media stream may be transmitted to a large number of client computers or the server may be transmitting media streams with differing content to different computers.

The streaming server receives a content signal 107 from a source and transmits the signal as a stream to packet network 103. The signal source may be a terrestrial radio station or television station, or other service that provides audio and/or video programming content. For reasons explained below, the system 100, in its preferred embodiment, may be used to best advantage in transmitting live radio broadcasts. Streaming encoder 109 digitizes, and if desirable, formats and encodes the signal as a stream. Any type of data transport mechanism may be used to transmit the content signal to system 100, including those that transmit the signal in a digital format. Other processes, not represented on the figure, handle the transport of the media stream over the connection of the streaming server to the packet network.

Content for a media stream, meaning an audio and/or video signal, is in the preferred embodiment provided in real time from a source. In the preferred embodiment, if the source of content signal 107 is a broadcast radio station or radio network, the signal that is broadcast is also being provided in real time for immediate streaming. Once the signal arrives, an audio automation system immediately connects it to the streaming encoder 109. The streaming encoder is in a preferred embodiment, an instance of a server component of any streaming application, such as RealPlayer®, QuickTime® or Windows Media Player™. In order to insert advertising into the stream, in real time, a trigger signal 106 from the source is also received. The trigger signal can be sent from the source separately, such as on a different channel, sent on the same channel as or otherwise encoded in the content signal from the source. The trigger signal indicates the start of a time period in which a message, such as an advertisement, a news item, stock alerts, an email message, a weather update, a voice mail message and/or the like may be inserted into the content. For example, the message may be an audio advertisement for a radio signal, or an audio/video advertisement for a television signal.

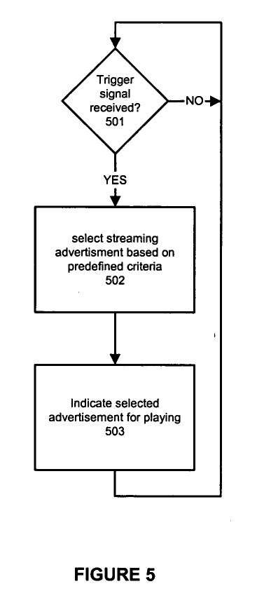

In the preferred embodiment, when audio automation system 108 receives a trigger signal, it plays an advertisement that has been queued according to a schedule or a predetermined order. In an alternative embodiment, the advertisements may be selected in real-time based on a set of one or more predefined criteria as discussed in more detail with reference to FIG. 5. The advertisements are stored in storage system 110. The playback of the advertisement is switched by the audio automation system to streaming encoder 109 in place of content signal 107. Thus, it is sent to all users receiving a stream from the URL that identifies the source of the stream. Once the advertisement is finished, audio automation system 108 switches back to the content signal 107 to provide a signal to the streaming encoder 109, or plays additional advertisements. A second trigger signal can be sent to indicate conclusion of the time period for advertisements, or the periods can be set to have a predetermined duration. In the event that the content signal is provided by a third party subscription service, the trigger can be used to signal the start of a new program that may permit insertion of an advertisement. An identifier included in the stream is changed to indicate that a different stream, namely the advertisement, is being sent.

Although not shown, streaming server 105 may communicate the media stream to other servers and/or one or more distribution networks that are connected to, or part of, packet network 103, in order to cache and/or geographically distribute the stream over high speed networks for purposes of enhancing delivery of the signal to each client computer 101. The stream may also be cached by these other services or networks.

The streaming server 105 may also receive signals from more than one source and concurrently transmit more than one media stream. Furthermore, more than one streaming server may be used to transmit additional media streams.

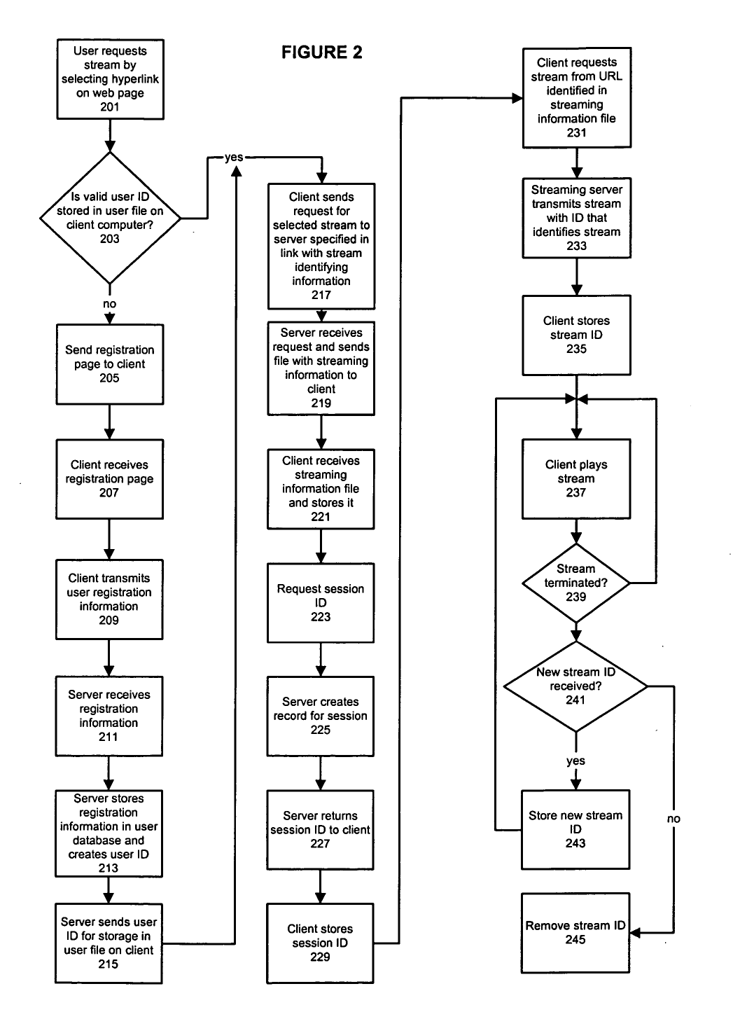

Referring now to FIGS. 1 and 2, to begin use of the streaming service, a client-server application such as the World Wide Web (or “web”) is used to exchange information with the user for setting up the service. The following description will be made in reference to a web server and a web browser as an example of a client-server application used to obtain information about streaming services and to setup streaming services. The Web has an advantage of being available for almost every type of computer. However, other client-server applications can be used to exchange set-up information for streaming services. Therefore, the web browser and web server can be replaced by other types of applications capable of displaying text and/or graphic information, such as those that may be required for computers with limited display or computing capabilities. Client computer 101 therefore includes a web browser 111. The user obtains a web page, such as an HTML encoded file, on which one or more links to streaming services content are included. At step 201 of the process illustrated by the flow diagram of FIG. 2, the user requests a stream by, for example, selecting a hyperlink on a web page. The web browser sends to web server 113 a user identifier, if there is one stored in a special user file on the client computer. Web server 113 passes the information to registration/log on logic 115, which then validates the user identifier. If no valid user identifier, or no user identifier at all, is sent, the registration process causes, as represented by decision step 203, the web server 113 to transmit at step 205 a registration page to web browser 111. At step 207, the web browser on the client computer displays the registration page. The registration page requests certain information and includes a form into which information is entered. Preferably, it includes information with which to identify the user, such as an Email address, a telephone number, a credit card number, a digital signature and/or other like information. With such identifying information, the opportunity for duplicate registrations can be reduced. Furthermore, the identifying information, such as the Email address can be, if desired, authenticated. The registration page or process may also, if desired, seek from the user certain demographic information, such as age, gender, income, place of residence, ethnicity, languages spoken, interests and/or the like.

In the preferred embodiment in step 209, the user sends the registration information to web server 113. Upon receiving the registration information in step 211, server 113 passes at least a portion of the received information to registration/log on logic 115 to be stored in user record database 116 in step 213. The database generates a unique user identifier that is sent to the client computer 101 in step 215.

Once a user identifier is stored on the client computer, the web browser continues with the process at step 217 of setting up the selected media stream for the user. The web browser sends a request to a second web server 117, using information associated with the link selected by the user at step 201, for information with which to set up the media stream. Included is information with which to identify the stream. When, as represented by step 219, this request is received by web server 117, the stream identifying information is passed to get streaming information logic 119, which then obtains the appropriate file stored in streaming information file directory or database 121. This file is transmitted by web server 117 to client computer 101. At step 221, the client receives and stores the file. In the preferred embodiment, this file includes a locator, such as a Universal Resource Locator (URL), from which the particular stream is available. Receiving this file causes, in the preferred embodiment, a player application 122 to be launched on client computer 101.

As represented by steps 223 and 225, once a user identifier is obtained, session tracking logic 123 creates a record in session records database 125 to track the user's session with the selected media stream. This session record includes, but is not limited to, fields for the user identifier, the time the media stream was set up, and/or information that identifies the media stream (e.g. the radio station broadcast including for example the particular advertisement) sent to the user. A session identifier that uniquely identifies the session is also generated and sent by session tracking logic 123 to client computer 101 in step 227 for storage by the client computer in step 229. The client computer 101 preferably stores the session identified in client session tracking logic 127.

Beginning with step 231 the client requests the stream from the URL provided in the file received at step 221. For purposes of this description, the URL points to a streaming service on streaming server 105, which is transmitting the stream from source 107. The streaming server begins transmitting the stream to client computer 101 in step 233, which preferably includes a stream identifier that is stored by the stream control logic 129 of player application 122 on client computer 101 in step 235. Player application 122 has embedded in or linked to it a streaming media client 131, such as Windows Media Player™, that actually controls the streaming and processes and decodes the stream in step 237 for playback on client computer 101 using its sound system and/or a connected sound system. If, as represented by decision steps 239 and 241, the stream terminates, the stream identifier is deleted at step 245. If a new stream identifier is received, it is stored in step 243 and the playing process continues at step 237. A session identifier for a streaming session can be used in place of the stream ID to identify the stream that the user is then currently receiving.

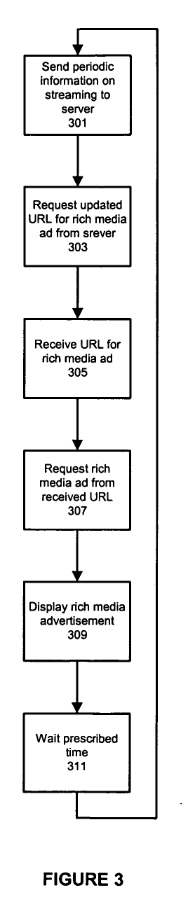

Referring now to FIGS. 1 and 3 in step 301, player application 122 sends information to web server 113. This information may be automatically sent on a periodic basis. This information preferably includes the user identifier, the session identifier and the stream identifier. This information is used by ad display logic 133 as part of a request sent to tracking web server 113 for an updated URL at step 303 for a rich media message, such as an advertisement. This rich media advertisement may include text, static graphic components, and/or active components, and may come from any third party. For example, such components may be for example a video component in MPEG, QT, MOV or other format, a presentation in Flash, an animated GIF and/or the like. It is preferably displayed in a rich media advertising window 135, which is in the preferred embodiment a web browser window that is displayed adjacent a window containing controls (such as volume controls) for player application 122 on the monitor of the client computer. Thus, when a user is receiving a media stream, the user is also viewing an advertisement. The ad display logic 133 can be implemented either as a periodic web page refresh or through client/server software. Once the URL for the rich media advertisement is received in step 305, the rich media advertisement is requested in step 307. In step 309, at least a portion of the received rich media advertisement is displayed. The player application waits for a prescribed time before repeating the process, as indicated by step 311.

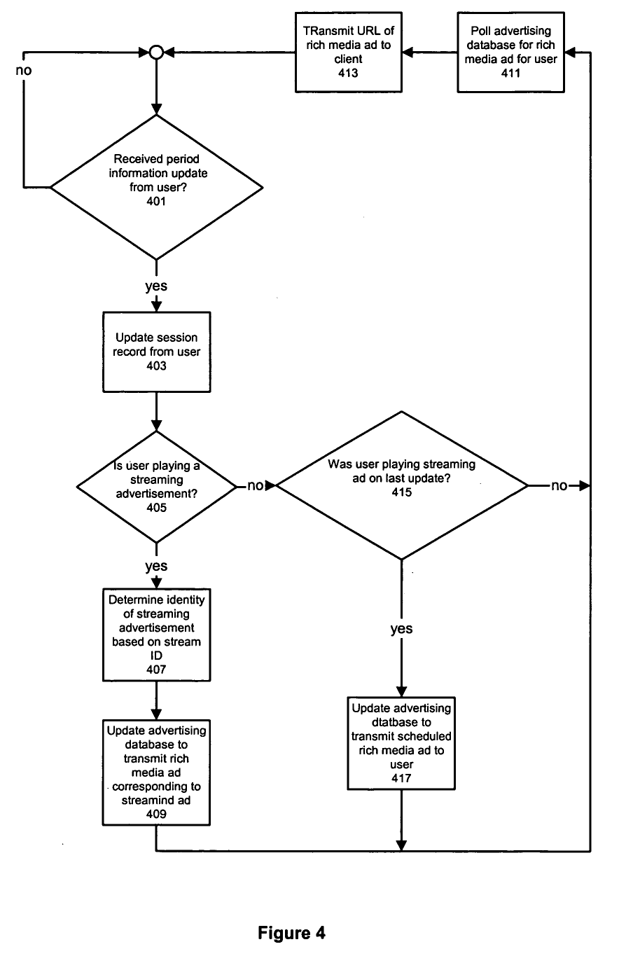

The preferred embodiment flow diagram of FIG. 4 represents the process on tracking server 113 that corresponds to the process represented by the flowchart of FIG. 3 that takes place on the client computer 101. This process will be described in connection with web server 113. However, as previously explained, other client/server software can be used to implement this process. Web server 113 waits, as indicated by decision step 401, to receive updated information from the computer of each user that uses the streaming services. When it receives updated information, web server 113 passes the information to session tracking logic 123, for updating the session record for the particular user in step 403. Advertising push logic 137 also receives information about the stream that is being played. If, as represented by step 405, the user is playing a message, such as an advertisement, that has been inserted into the stream according to a process that will be described below, the identity of the streaming advertisement is available as a stream or session identifier, as indicated at step 407. Preferably the stream identifier is used to look up in the advertising scheduling database 139 or some other database the URL of a rich media advertisement that is to be shown at the same time streaming advertisement is played. In step 409, the advertising scheduling database 139 is updated with this information so that, when the advertising push logic 137 polls the database at step 411 for the URL of the advertisement to be shown, the URL for this rich media advertisement is transmitted to the client at step 413. If the user was not playing a streaming advertisement at step 405, but was playing such an advertisement during the last update, then it updates advertising schedule database to transmit the rich media advertisement when the advertising push logic polls the advertising schedule database, as indicated by steps 415 and 417. In a preferred embodiment the advertising schedule database is updated with a previously scheduled advertisement. However, if desired, in alternative embodiments the advertising schedule database may be updated with an advertisement selected in real-time based on one or more predefined criteria as discussed in more detail with reference to FIG. 5. If no streaming advertisement was being played on the prior update, then step 417 is skipped. Web server 117 is illustrated as providing the rich media advertising files. If the URL provided by the process of FIG. 4 points to a rich media advertising file stored in database or file system 143, then get rich media ad logic 141 retrieves the files for the advertisement and provides them to web server 117 to send. However, the URL may also point to any other resource on packet network 103.

Referring now only to FIG. 1, client computers 145 and 147, each running a web browser, are representative of a feature that permits remote viewing in real time, through a public packet network, how many people are actually listening to the content, as well as when they listened and how long they listened. This feature may be made available to the content providers and to advertisers, as it also indicates who has listened to and/or viewed advertisements. Thus, it is possible to charge advertisers based not only on how many people actually saw or heard an advertisement, but also their demographic profile. In the illustrated example, user reporting logic 149, in response to a request from client computers 145 and 147 to web server 113, has generated different user tracking reports 151 and 153. The reports have been sent by web server 113 for display preferably in web browsers on those client computers.

Additionally, advertising can also be scheduled remotely using web server 113 and advertising scheduling logic 155. The advertising scheduling logic creates an interface 159 that is displayed on client computer 157. The interface permits adding, modifying and deleting advertising schedules for the rich media advertising.

Web servers 113 and 117 do not necessarily correspond to physical machines. Rather, they represent different instances of a web server, which may or may not be running on the same physical hardware. Similarly, one or more instances of web servers may be used, and multiple instances may be distributed in terms of physical location, depending on loads or other needs of the service provider or particular implementation. The logic that is illustrated—namely advertising scheduling logic 155, advertising push logic 127, user reporting logic 149, registration/log on logic 115, session tracking logic 123, get streaming information logic 119, and get rich media advertising logic 141—represent classes of computer programs or scripts which may have many instances at any given time. They may or may not run on the same physical hardware as the web servers and thus, too, may be distributed. For example, in the preferred embodiment, that may be instances of dynamic link libraries that are invoked by the web browsers. The lines extending between the various entities in FIG. 1 indicate message and data flows, and not physical connections. Player application 122 may, alternatively, be implemented as a web page with active components, with the rich media advertisements displayed in a frame.

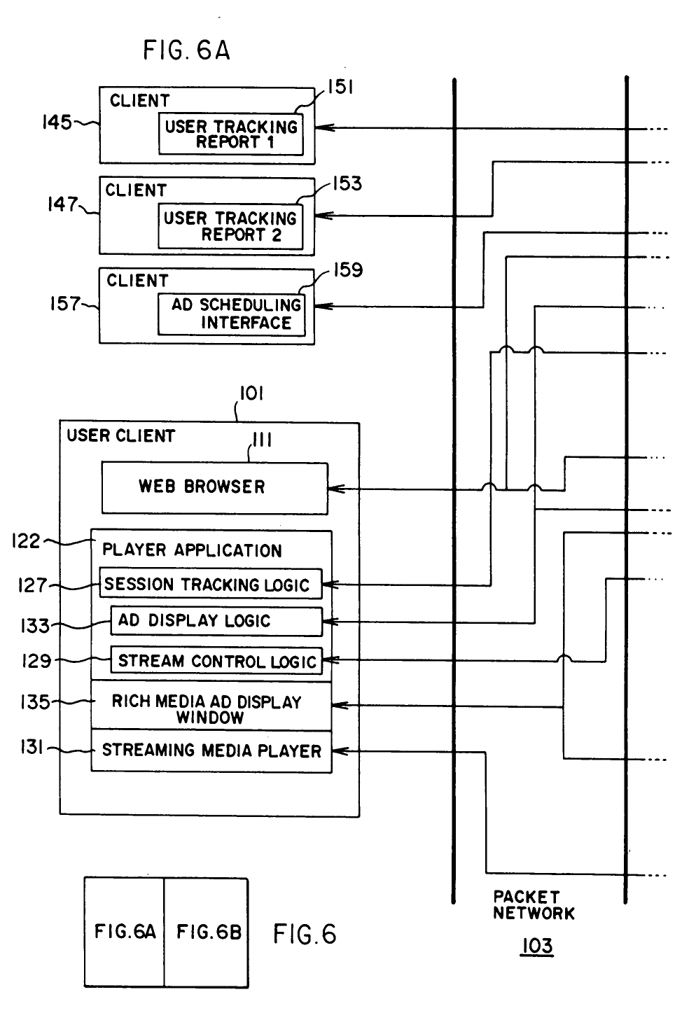

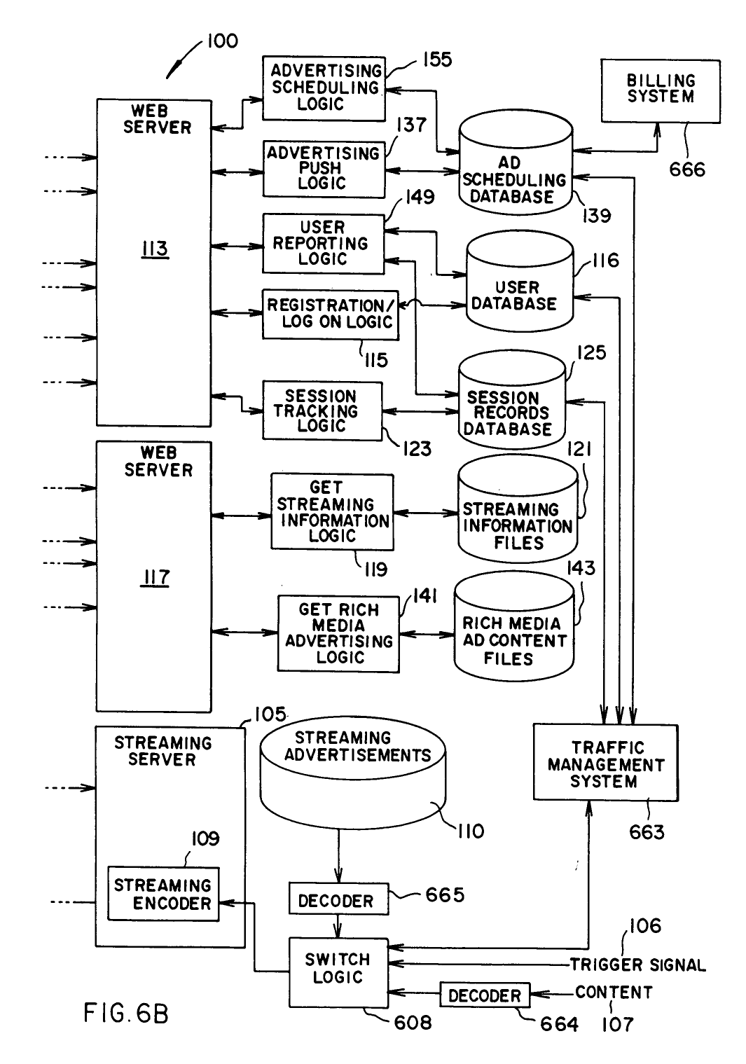

Referring now to FIGS. 5 and 6, an alternative embodiment for a client server system 600 for streaming audio and video, tracking users, selecting advertisements in real time and pushing rich media advertising is shown. The block schematic diagram of FIG. 6 is substantially the same as the diagram of FIG. 1. However, the client server system of FIG. 6 differs in ways described below. A decoder 664 is provided such that if the content signal is in a coded or compressed format, the decoder 664 decodes or decompresses the signal. Furthermore a decoder 665 is preferably included between a switch logic 608 and streaming advertisements database 110. Advertisements in the streaming advertisements database 110 are preferably stored in a compressed format and are decoded by decoder 665 prior to providing to switch 608.

As indicated by decision step 501 traffic management logic 663 waits to receive an indication that a trigger has been received. Traffic management logic 663 is implemented, for example, as a program or multiple programs running on one or more computers. In step 502 one or more streaming advertisements are selected, based on one or more predefined criteria, to be played during a commercial break in the content. In step 503, the selected advertisement(s) are indicated to or identifies for the switch logic 608. Switch logic 608, like audio automation system 108, detects the trigger signal. However, it also requests from the traffic management system a streaming advertisement to play and then retrieves it from the streaming advertisements database 110. The switch logic can be a programmed process on a computer with multiple sound cards.

In the preferred embodiment, the traffic management system 663 writes to the ad scheduling database 139 information identifying which streaming advertisement was played and when it was played. Other information, such as the criteria used to select the advertisement and information for determining which rate to be charged to the advertiser, can also be written to the ad scheduling database 139 for use by the billing system 666 to create statements or bills for the advertisers. This information may include the time of day, the number of users who received the streaming advertisement (referred to as “impressions”), the demographic information of the users, the station identifier, the spot number and/or the like. In the preferred embodiment, the cost of the advertisements are calculated using rates based on cost per thousand impressions multiplied by the number of impressions.

In a preferred embodiment, the demographic composition of the users to whom a particular streaming media is being transmitted is used as a criteria to select the streaming advertisement. The traffic management logic 663 preferably determines the demographic composition of the users listening to a particular stream. Thus, selection of an advertisement for streaming may be, if desired, based on whether the demographic composition of the users matches or fits the demographic profile associated with the particular advertisement. In the illustrated embodiment the demographic composition of the users is determined by the traffic management logic 663. In the illustrated embodiment, the traffic management logic 663 accesses the session records database 125 and acquires the user identifiers of a plurality of users associated with a particular streaming session. The user identifiers are used by the traffic management logic 663 to look up the profile of the users stored in the user records database 116.

Information about the preferred target audience of a particular advertisement may be associated with the advertisement and stored in the ad scheduling database 139 along with the particular advertisement. Thus, information from the user database 116 may be used to select a particular advertisement to be played. Thus, whether a particular advertisement is selected for playing will depend, at least in part, on the demographic profile, such as for example the age, gender, income, place of residence, ethnicity, interests and/or the like of the users. For example, an advertiser may have two “spots”, one targeted for one demographic and the other targeted to a different demographic. The most appropriate advertisement can be selected based on which demographic is most prevalent among the users. Furthermore, if desired, each of these demographic criteria may be given a particular weight in the selection process such that a particular demographic criteria is given more importance in the selection process. For example, advertisers for local goods and/or services may be more interested in the geographical location of a user, then their income and thus, may assign a greater weight to the place of residence.

In the illustrate embodiment, predefined criteria may be used to enforce product code separation. A product code indicates the product that a particular streaming advertisement is related to. For example, the streaming advertisement database may include one or more advertisements for cars from different manufacturers. The product code for all such advertisements may be the same indicating that all of the advertisements relate to cars irrespective of the manufacturer. A product code separation criteria can be used to enforce an advertiser's requirement or preference that some number of advertisements or some amount of time pass between playing of advertisements of the same product class or type. Ad scheduling database 139 may include information associated with each advertisement, such as a particular advertiser's preferences as to product code separation. In such a case, a particular advertiser could specify for example the number of advertisements or a time period that would separate that particular advertiser's advertisement from an advertisement related to a product having the same or similar product code. Use of a product code separation will, when selecting advertisements for play in real-time, prevent inadvertent violation of the product separation requirements or preferences.

Additional predefined criteria for selecting may be based, for example on the frequency of play. Thus, whether a particular advertisement is selected for playing in real time could depend on when that particular advertisement was last played. The information regarding when a particular advertisement was last played could be obtained for example from the session records database 125 and/or the session tracking logic 127. In the preferred embodiment, the same advertisement is not played around the same time everyday. Thus, if a particular advertisement was played at a particular time the previous day, then in the preferred embodiment, that same advertisement would not be played during the same time the next day.

Alternately, the selection of the advertisement may precede actual receipt of a trigger to improve performance, or for other reasons, provided the selection is made in close proximity to receiving the trigger signal. The advertisement could be streamed to the users upon receiving the trigger. For example, because in the preferred embodiment, user session records are only updated periodically, the traffic management logic 663 need only periodically generate the demographic composition of the users. This could improve the performance of the system in providing advertisements in real time. Furthermore, if desired, some of the predefined criteria may be calculated or applied prior to receiving the trigger signal while other predefined criteria may be applied after receiving the trigger signal.

In a preferred embodiment, during the selection process a first criteria, for example the demographic composition of the users is applied to a plurality of advertisements, say advertisements scheduled to be played during a particular period of the day (for example, evening drive time) to provide a subset of the plurality of advertisements. A second criteria, say frequency of play, may then be applied to this subset of advertisements to provide a smaller subset of advertisements. A third criteria, say product code separation, may then be applied to this smaller subset to select one or more advertisements to be played. If there are more than one advertisements that meet all three criteria, then these advertisements could be played based on a priority basis or some other bases.

Although the real time selection of streaming advertisements is described above with reference to certain criteria only, any one or any number of criteria, as well as other criteria, may be used to select a streaming advertisement in real time. Moreover, it is not necessary that all the criteria be considered in selecting the particular advertisement to be displayed. Any one or more than one combination of criteria may be used for selecting an advertisement to be played. Furthermore, weights may be assigned to each of the predefined criteria so that a particular predefined criteria is given more importance in the selection process than other criteria.

In alternative embodiments, a set of advertisements may be queued in advance with alternate “spots” provided based on predefined criteria such as demographics, or with the predefined criteria acting as a screen to prevent playing of the advertisement. For example, advertisement numbers 1, 2, 3, 4 and 5 may be scheduled to be delivered in that order in a particular time slot. However, if the traffic management system determines that advertisement 2 is targeted to teenage girls while the particular listeners are retired males, advertisement 2 can be skipped and advertisement 3 is played or an alternate spot played in place of advertisement 2.

The advertisement selection process as described above with respect to the flowchart of FIG. 5 provides certain advantages not provided by prior art systems. For example, because it is capable of selecting in real-time advertisements to be played, the advertisements may be better targeted to an advertiser's preferred audience. Furthermore, because a user is receiving advertisements for products and/or services that it is interested in, the user is able to receive better information. This may provide a competitive advantage to the particular content provider, such as a radio station, because the users would prefer receiving content from a content provider that also provides them useful information during commercial breaks than a content provider who does not provide them useful information during commercial breaks.

The forgoing description is an example of one embodiment of the invention. The invention is not, however, limited to the described and illustrated embodiment. Elements and features of this embodiment may be omitted or altered, and features and elements added, without departing from the scope of the invention, which is defined solely by the appended claims.

What is claimed is:

1. A method for streaming media over packet networks, comprising the steps of:
receiving a first content signal from a source;
establishing a streaming session with a user computer over a packet switched data network;
streaming said first content signal over said data network during said streaming session;
in response to a trigger, selecting in real time a second content signal to be streamed in place of said first content signal; and
streaming said selected second content signal.

2. The method of claim 1, wherein said second content signal includes advertising information.

3. The method of claim 2, wherein said selection in real time of said second content signal is based in part on a set of predefined criteria.

4. The method of claim 3, wherein at least one criteria of said set of predefined criteria is selected from the group consisting of a product code separation, a frequency of streaming, and a demographic profile of a user of said user computer.

5. The method of claim 4, wherein said product code separation is based in part on a stream identifier associated with said streaming session, wherein said stream identifier identifies a particular product associated with said advertising information.

6. The method of claim 3, wherein said advertising information is selected from a plurality of advertisements stored in a streaming advertisements database, wherein said plurality of advertisements are prearranged in a scheduled order and said selecting step rearranges said prearranged order based on said set of predefined criteria.

7. The method of claim 2, wherein said advertising information includes an audio component.

8. The method of claim 2, wherein said advertising information includes a video component.

9. The method of claim 7, wherein said audio component is in MP3 format

10. The method of claim 8, wherein video component is in a format selected from the group consisting of MPEG, MOV, QT, and animated GIF.

11. A computer program for providing streaming media over a packet switched network to a user computer, the computer program comprising:
a user component for use by a user computer; and
a provider component on a provider server for use by a provider of said streaming media, wherein said provider component includes:
code for receiving relevant information from said user component;
code for streaming a content signal received from a source to said user component;
code for receiving a trigger signal from said source;
code for selecting, upon receiving said trigger signal, in real time content information to be provided to said user computer based in part on information received from said user component over a packet switched data network, wherein said selection is based on a predefined set of criteria; and
code for streaming said selected content information over said data network to said user computer.

12. The computer program of claim 11, wherein said selected information includes a plurality of advertisements and wherein said provider component further comprises:
code for rearranging a prearranged order of streaming said plurality of advertisements, wherein said rearranging is based on said predefined set of criteria.

13. A system for streaming media over packet networks, comprising:
means for receiving a first content signal from a source;
means for establishing a streaming session with a user computer over a packet switched data network;
means for streaming said first content signal over said data network during said streaming session;
means for streaming, in response to a trigger, a second content signal, wherein said second content signal to be streamed is selected in real time.
